(19) United States
(12) Patent Application Publication
(10) Pub. No.: US 2014/0031470 A1
(43) Pub. Date: Jan. 30, 2014

(54) DIAMINO ALCOHOL AND STRONG BASE NEUTRALIZERS FOR LOW VOC COATING COMPOSITIONS

(71) Applicants: Esin Busche, Buffalo Grove, IL (US); Asghar Peera, Cary, IL (US); John Quinn, Morton Grove, IL (US); Raymond Swedo, Mount Prospect, IL (US); Anurima Singh, Midland, MI (US); Ian A. Tomlinson, Midland, MI (US)

(72) Inventors: Esin Busche, Buffalo Grove, IL (US); Asghar Peera, Cary, IL (US); John Quinn, Morton Grove, IL (US); Raymond Swedo, Mount Prospect, IL (US); Anurima Singh, Midland, MI (US); Ian A. Tomlinson, Midland, MI (US)

(21) Appl. No.: 13/978,962

(22) PCT Filed: Dec. 22, 2010
(86) PCT No.: PCT/US10/03232

§ 371 Date: Oct. 9, 2013

(51) Int. Cl. C09D 7/12

(52) U.S. Cl. CPC C09D 7/1233
USPC 524/249

(57) ABSTRACT

A coating composition comprising a binder, a carrier, a pigment, cations selected from the group consisting of alkali metal cations, ammonium cations, and mixtures thereof, and at least one diamino alcohol selected from the group consisting of compounds of Formula I and compounds of Formula II. The present invention also provides a method for reducing the volatile organic compound (VOC) content of a coating composition having a binder, a carrier, and a pigment, which comprises including in the coating composition the aforesaid A) cations and B) at least one diamino alcohol.

The diamino alcohol may be of Formula I:

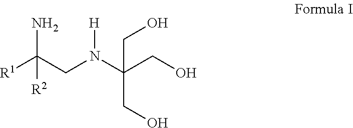

wherein R¹ and R² are independently C₁-C₁₀ alkyl, or R¹ and R², together with the carbon to which they are attached, form a C₃-C₁₂ cycloalkyl ring optionally substituted with C₁-C₆ alkyl. For example, the compound of Formula I may be 2-(2-amino-2-methylpropylamino)-2-(hydroxymethyl)propane-1,3-diol.

Alternatively, the diamino alcohol may be of Formula II:

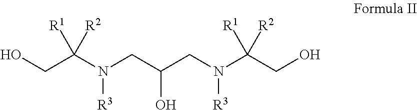

or salt thereof, wherein R¹ and R² are independently at each occurrence C₁-C₆ alkyl; and R³ is independently at each occurrence H or C₁-C₆ alkyl. For example, the compound of Formula II may be 2,2′-((2-hydroxytrimethylene)diimino)bis(2-methyl-1-propanol).

### FIELD OF THE INVENTION

The invention relates to the use of a combination of certain diamino alcohols with a strong base as a neutralizer in coating compositions having low volatile organic compound (VOC) content.

### BACKGROUND OF THE INVENTION

Amino alcohols are used in aqueous coating formulations, such as latex paints, as neutralizing agents to raise the pH of the paint to a desired value, typically between 8 and 10, and especially between 8 and 9.5. In many geographies, paint manufacturers are facing regulations to reduce the volatile organic content (VOC) of their compositions.

2-Amino-2-methyl-1-propanol (AMP) has been the industry standard amino-alcohol to increase the pH while simultaneously enhancing pigment dispersion and stability. AMP has been shown to help in the development of coating compositions with lower VOC by enabling reduction of other VOC components in the formulation. However, as the industry moves towards no VOC formulations, the volatility of AMP makes it less desirable since it is itself a VOC contributor. In fact, AMP exhibits a VOC contribution of 100%.

Two alternatives for use as neutralizers, that are by definition non VOC contributors, are ammonia and strong inorganic bases, such as KOH or NaOH. Ammonia, while an efficient neutralizer, has a very strong odor and is unsuitable for use in low odor paint. Inorganic bases result in coatings with poor scrub resistance. Furthermore, unlike amine compounds, neither ammonia nor inorganic bases assist in dispersion of pigments in the coating composition.

A variety of very low VOC or no VOC amine additives have been developed. These include, for example, AEPD VOX 1000 (2-amino-2-ethyl-1,3-propanediol) (commercially available from ANGUS Chemicals of Buffalo Grove, Ill., a subsidiary of The Dow Chemical Company of Midland, Mich.), DMTA (N,N-dimethyl-tris-hydroxymethylaminomethane), AMP-dimer 2,2′-((2-hydroxytrimethylene)diimino)bis(2-methyl-1-propanol), and TA-ACyHM 2-((1-aminocyclohexyl)methylamino)-2-(hydroxymethyl)propane-1,3-diol. These materials are effective at the dispersal of pigments, resulting in improvement in paint properties related to dispersion. However, all have a lower neutralizing efficiency compared to AMP.

U.S. patent application Ser. No. 12/957,958, filed Dec. 1, 2010, describes the preparation and use of aminoalcohol compounds as additives for low odor, low volatile organic content (VOC) paints and coatings.

International Patent Application Publication No. WO 2010/126962 discloses the use of polyhydroxy-diamine compounds as neutralizers in aqueous paint or coating formulations which comprise a binder, a carrier, a pigment and a polyhydroxy-diamine. The polyhydroxy-diamines are also useful as hardeners and adhesion promoters in curable epoxy resin formulations.

International Patent Application Publication No. WO 2010/126657 discloses the use of tertiary amino alcohol compounds as low VOC, low odor neutralizers for paints and coatings containing a binder, a carrier, a pigment and an effective amount of a tertiary amino alcohol compound.

U.S. Patent Application Ser. No. 61/284,608, filed Dec. 22, 2009, describes novel diamino alcohol compounds and their use in low VOC and no VOC aqueous coating compositions which also contain an aqueous carrier, a pigment and an acrylic, methacrylic, vinyl ester or styrene resin binder.

U.S. Patent Application Ser. No. 61/456,528, filed Nov. 8, 2010, teaches the use of an alkanolamine neutralizer for water-containing coating compositions which also contain a binder, a hydrophobically modified alkali soluble emulsion having pendant COO⁻ groups (HASE), alkali metal or ammonium cations. The alkanolamine neutralizer has, among other characteristics, 1 to 2 nitrogen atoms and 2 to 4 hydroxyl groups.

Efficient neutralizing agents, which exhibit low or no VOC and have very low or no amine odor, without interfering with other desired properties such as scrub resistance, and freeze-thaw stability, would be a significant advance for the paints and coatings industry.

The present invention provides no VOC coating compositions using less of a lower efficiency, higher cost neutralizer in conjunction with a strong base, while retaining the excellent film properties comparable to coatings containing AMP-based neutralizers.

### SUMMARY OF THE INVENTION

The present invention is a coating composition comprising a binder, a carrier, a pigment, cations selected from the group consisting of alkali metal cations, ammonium cations, and mixtures thereof, and at least one diamino alcohol selected from the group consisting of:
A) a compound of Formula I as follows:

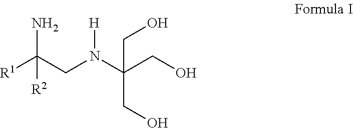

wherein, wherein R¹ and R² are independently C₁-C₁₀ alkyl, or R¹ and R², together with the carbon to which they are attached, form a C₃-C₁₂ cycloalkyl ring optionally substituted with C₁-C₆ alkyl; and
B) a compound of Formula II as follows:

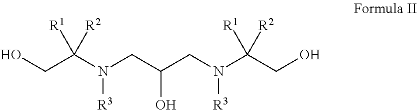

or salt thereof, wherein R¹ and R² are independently at each occurrence C₁-C₆ alkyl; and R³ is independently at each occurrence H or C₁-C₆ alkyl.

For example, without limitation, the diamino alcohol may be a compound of Formula I which comprises 2-((1-aminocyclohexyl)methylamino)-2-(hydroxymethyl)propane-1,3-diol. Alternatively, without limitation, the diamino alcohol may be a compound of Formula II which comprises 2,2′-((2-hydroxytrimethylene)diimino)bis(2-methyl-1-propanol).

In one embodiment, the coating composition is a low VOC composition and has a volatile organic compound (VOC) content of less than 50 grams per liter of VOC, based on the total volume of the coating composition.

Another aspect of the present invention provides a method for reducing the volatile organic compound (VOC) content of a coating composition having a binder, a carrier, and a pigment, said method comprising including in the coating composition:
A) cations selected from the group consisting of alkali metal cations, ammonium cations, and mixtures thereof; and
B) an effective amount of at least one diamino alcohol selected from the group consisting of:
   1) a compound of Formula I as follows:

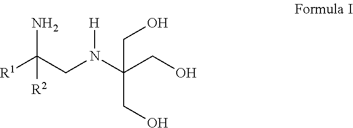

wherein, wherein R¹ and R² are independently C₁-C₁₀ alkyl, or R¹ and R², together with the carbon to which they are attached, form a C₃-C₁₂ cycloalkyl ring optionally substituted with C₁-C₆ alkyl; and
2) a compound of Formula II as follows:

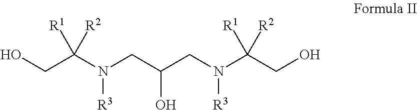

or salt thereof, wherein R¹ and R² are independently at each occurrence C₁-C₆ alkyl; and R³ is independently at each occurrence H or C₁-C₆ alkyl.

In some embodiments, the diamino alcohol may be a compound of Formula I which comprises 2-((1-aminocyclohexyl)methylamino)-2-(hydroxymethyl)propane-1,3-diol and, in others it may be a compound of Formula II which comprises 2,2′-((2-hydroxytrimethylene)diimino)bis(2-methyl-1-propanol).

### DETAILED DESCRIPTION OF THE INVENTION

All percentages are by weight unless otherwise specified.

The term “alkyl” as used herein, means a straight or branched chain hydrocarbon containing the indicated number of carbon atoms. If no number is indicated, then alkyl contains from 1 to 6 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, and n-hexyl.

The term “low VOC,” as used herein, means compositions having less than 50 grams per liter of VOC, based on the total volume of the composition. The term “no VOC” or “zero VOC,” as used herein, means compositions having less than 5 grams per liter of VOC, based on the total volume of the composition. For purposes of the following discussion, a composition's VOC content is measured using EPA Test Method 24: Determination of Volatile Matter Content, Water Content, Density, Volume Solids, and Weight Solids of Surface Coatings.

The invention provides a coating composition comprising a binder, a carrier, a pigment, cations selected from the group consisting of alkali metal cations, ammonium cations, and mixtures thereof, and at least one diamino alcohol selected from the group consisting of compounds of Formula I and compounds of Formula II, as described in further detail hereinafter.

The present invention also provides a method for reducing the volatile organic compound (VOC) content of a coating composition having a binder, a carrier, and a pigment, said method comprising including in the coating composition: A) cations selected from the group consisting of alkali metal cations, ammonium cations, and mixtures thereof; and B) an effective amount of at least one diamino alcohol selected from the group consisting of compounds of Formula I and compounds of Formula II, as described in further detail herienafter.

The at least one diamino alcohol may be of Formula I:

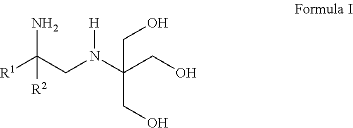

wherein R¹ and R² are independently C₁-C₁₀ alkyl, or R¹ and R², together with the carbon to which they are attached, form a C₃-C₁₂ cycloalkyl ring optionally substituted with C₁-C₆ alkyl.

In one embodiment, R¹ in the compounds of Formula I is a C₁-C₃ alkyl. In a further embodiment, R¹ is methyl.

In one embodiment, R² in the compounds of Formula I is a C₁-C₃ alkyl. In a further embodiment, R² is methyl.

In a further embodiment, R¹ and R² are each, independently, a C₁-C₃ alkyl.

Additionally, in other embodiments, R¹ and R² in the compounds of Formula I, together with the carbon to which they are attached, form a C₃-C₁₂ cycloalkyl ring. In a further embodiment, R¹ and R² form a C₅-C₈ cycloalkyl ring. The ring is optionally substituted with 1 or 2 C₁-C₆ alkyl substituents, such as groups independently selected from methyl, ethyl, and propyl.

For example, in accordance with the present invention, the compound of Formula I may be 2-(2-amino-2-methylpropylamino)-2-(hydroxymethyl)propane-1,3-diol (“TA-AMP”) (i.e., R¹ and R² in formula I are both methyl). As another example, the compound of formula I may be 2-((1-aminocyclohexyl)methylamino)-2-(hydroxymethyl)propane-1,3-diol (i.e., R¹ and R² and the carbon to which they are attached form a cyclohexyl ring). Alternatively, the at least one diamino alcohol may be of Formula II:

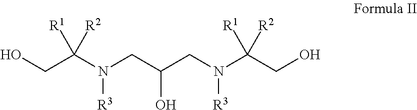

or salt thereof, wherein R¹ and R² are independently at each occurrence C₁-C₆ alkyl; and R³ is independently at each occurrence H or C₁-C₆ alkyl.

In one embodiment, R¹ in the compounds of Formula II is, at each occurrence, a C₁-C₃ alkyl. In a further embodiment, R¹ is methyl at each occurrence.

In one embodiment, R² in the compounds of Formula II is, at each occurrence, a C₁-C₃ alkyl. In a further embodiment, R² is methyl at each occurrence.

Also in a further embodiment, R³ is H at each occurrence.

For example, in accordance with the present invention, the compound of Formula II may be 2,2′-((2-hydroxytrimethylene)diimino)bis(2-methyl-1-propanol) (AMP dimer) (i.e., R¹ and R² in formula (I) are methyl at each occurrence, and R³ is H at each occurrence).

While thickeners known as hydrophobically modified alkali soluble emulsions (“HASE”), which have pendant COO groups, may also be included in the coating composition according to the present invention, it is not necessary. In fact, coating compositions comprising the cations and diamino alcohols described hereinabove, but lacking HASE thickeners, have performance characteristics comparable to and, in some instances, superior to coatings containing established amine neutralizers such as AMP.

The combination of cations (e.g., from a strong base) and at least one diamino alcohol described above are used in coating compositions to raise the pH to a desired value, typically between about 8 and 10, such as for example without limitation, between about 8.5 and 9.5. Thus, as will be readily understood by persons of ordinary skill in the relevant art, an “effective amount” of the diamino alcohol will be that amount required to provide a final pH of the coating composition in the range of about 8 and 10, such as between about 8.5 to 9.5.

As discussed previously, replacement of AMP or other established neutralizer amines with low VOC amine compounds such as, without limitation, AEPD VOX 1000 (2-amino-2-ethyl-1,3-propanediol), DMTA (N,N-dimethyl-tris-hydroxymethylaminomethane), AMP-dimer 2,2′-((2-hydroxytrimethylene)diimino)bis(2-methyl-1-propanol), TA-ACyHM 2-((1-aminocyclohexyl)methylamino)-2-(hydroxymethyl)propane-1,3-diol, and VANTEX-T (N-butyldiethanolamine, commercially available from Taminco Higher Amines of Allentown, Pa., U.S.A., see International Patent Application Publication WO 2008/081036) did reduce the VOC content of the resulting coating compositions and maintain adequate pigment dispersion. However, the neutralization strength diminished, which required that greater amounts of the aforesaid low VOC amine compounds be used to achieve that same degree of neutralization of the coating compounds. It has been discovered that, in accordance with the present invention, some proportion of the amino-alcohols used to neutralize the paint formulations could be reduced, by substitution with a strong base that provides alkali metal or ammonium cations, without an unacceptably negative effect on the properties of the final coating formulation. The amount of the diamino-alcohols AMP-Dimer and TA-AcyHM could be reduced to levels lower than that required when AMP was used, without deleterious effect on the desired properties of the final paint coating composition. This was very surprising and unanticipated, whereas it was also found that the mono-amines, e.g. AEPD and DMTA, could only be partially replaced by sodium hydroxide and could not be lowered to an equivalent weight of AMP before compromising some of the desired properties of the coating composition.

While the coating compositions of the present invention will hereinafter be discussed in the context of aqueous paint compositions, it will be understood by persons of ordinary skill in the art that the coating compositions of the present invention may be suitable for use in other coating applications as well.

Aqueous based coating compounds, or paints, comprising cations and at least one diamino alcohol as explained hereinabove in accordance with the present invention, are useful for providing protective and/or decorative barriers for residential and industrial surfaces, such as for floors, automobiles, exteriors and interiors of houses, and other buildings.

Pigments are used to provide the desired color to the final coated material and may also be used to provide bulk to the paint or coating. While multiple pigments may be present in end-use paints or coatings, sometimes only a white pigment, such as a zinc oxide and/or a titanium oxide, is added in the early stages of the formation of the formulation. Any other desired pigments of various colors (including more white pigment) can optionally be added at the later stages of, or after, the formulation is formed.

Pigments may be organic or inorganic. Examples of pigments can include, but are not limited to, titanium dioxide, kaolin clay, calcined kaolin clay, carbon black, iron oxide black, iron oxide yellow, iron oxide red, iron oxide brown, organic red pigments, including quinacridone red and metallized and non-metallized azo reds (e.g., lithols, lithol rubine, toluidine red, naphthol red), phthalocyanine blue, phthalocyanine green, mono- or di-arylide yellow, benzimidazolone yellow, heterocyclic yellow, quinacridone magenta, quinacridone violet, and the like, and any combination thereof.

Binders are included in the paint and coating compositions to provide a network in which the pigment particles are dispersed and suspended. Binders bind the pigment particles together and provide integrity and adhesion for the paint or coating film. Generally, there are two classes of binders: latex binders are used in aqueous based compositions, and alkyd-based binders are used in non-aqueous compositions, ultimately resulting in latex paints and coatings and alkyd paints and coatings, respectively.

In latex based paint and coating compositions, the binders are typically prepared by free radical initiated aqueous emulsion polymerization of a monomer mixture containing alkyl acrylate (methyl acrylate, ethyl acrylate, butyl acrylate and/or 2-ethylhexylacrylate), alkyl methacrylate, vinyl alcohol/acetate, styrene, and/or acrylonitrile and ethylene type monomers. The amount of the binder in the compositions of the invention can be the amount conventionally used in paint and coating compositions. By way of non-limiting examples, the amount of binder solids may be from about 2% to about 75%, alternatively from about 5% to about 65%, or alternatively from about 20% to about 55%, by weight based on the total weight of the formulation.

The compositions also contain a carrier in which the formulation ingredients are dissolved, dispersed, and/or suspended. In the aqueous based compositions of the invention, the carrier is usually water, although other water-based solutions such as water-alcohol mixtures and the like may be used. The aqueous carrier generally makes up the balance of the formulation, after all the other ingredients have been accounted for.

Other additives may be included in the paint and coating compositions besides the neutralizing agents, pigments, binders, and carriers discussed above. These include, but are not limited to, leveling agents and surfactants, rheology modifiers, co-solvents such as glycols, including propylene glycol or ethylene glycol, corrosion inhibitors, defoamers, co-dispersants, additional aminoalcohol compounds, and biocides.

The paint and coating compositions of the invention may be manufactured by conventional paint manufacturing techniques, which are well known to those skilled in the art. Typically, the compositions are manufactured by a two-step process. First, a dispersion phase, commonly referred to as the grind phase, is prepared by mixing the dry pigments with other grind phase components, including most other solid powder formulation materials, under constant high shear agitation to provide a high viscosity and high solids mixture. This part of the process is designed to effectively wet and dis-agglomerate the dry pigments and stabilize them in an aqueous dispersion.

The second step of the paint manufacturing process is commonly referred to as the letdown or thindown phase, because the viscous grind is diluted with the remaining formulation components, which are generally less viscous than the grind mix. Typically, the binders, any predispersed pigments, and any other paint materials that only require mixing and perhaps moderate shear, are incorporated during the letdown phase. The letdown phase may be done either by sequentially adding the letdown components into a vessel containing the grind mix, or by adding the grind mix into a vessel containing a premix of the latex resins and other letdown components, followed by sequential addition of the final letdown components. In either case, constant agitation is needed, although application of high shear is not required. The strong base for donating alkali metal or ammonium cations, and at least one diamino alcohol of Formula I or II are typically added, separately or together, in accordance with the present invention, to the coating composition at one or more of three different places in the manufacturing process: to the pigment dispersion, to the binder dispersion, and/or in a final addition to the paint formulation. The total amount of each to be used is determined based on the desired pH of the formulation. As already mentioned, typically, an effective amount of each of the strong base and at least one diamino alcohol is added so as to provide a final pH in the range of about 8 and 10.

The following examples are illustrative of the invention but are not intended to limit its scope.

### EXAMPLES

### Paint Formulation

A vinyl-acrylic semi-gloss paint formulation was prepared in ˜1-quart batches using high-shear mixer-dispersers. A Cowles-type blade of 1.625-inch diameter was used for the grinds, and a 2-Paint Formulation

A vinyl-acrylic semi-gloss paint formulation was prepared in ˜1-quart batches using high-shear mixer-dispersers. A Cowles-type blade of 1.625-inch diameter was used for the grinds, and a 2¾-inch propeller-type blade was used for the letdowns. A combined grind premix was made containing water, thickener, surfactant, dispersant, and defoamer, and a combined letdown premix was made containing latex, water, coalescent, and defoamer. These premixes were kept under continuous agitation except to weigh out amounts required for individual paint batches. Single beakers were then used for each individual batch; formulas allowed for water to rinse the grind blade before replacement with the letdown blade. Amines were added during the grind phase as 20% active aqueous solutions. Sodium hydroxide was added during the grind as a 10% aqueous solution.

### pH, Low Shear & High Shear Viscosity

The pH of each formulation was measured with a glass pH electrode. Krebs-units (KU) viscosity was measured with a Stormer viscometer with a stroboscopic timer (A.S.T.M. D 562). Sample temperatures were 25° C., except for the initial values, due to the warming during mixing. The high shear (“ICI”) viscosity was measured according to A.S.T.M. D 4287 using a Brookfield CAP 1000+viscometer, at a shear rate of 12,000 s⁻¹ (900 rpm, with a 0.45° cone of radius of 1.511 cm), with sample temperature controlled at 25° C. Sub-samples of the paints were put in a 60° C. oven for heat aging stability and pH and viscosity were measured at the times indicated in the respective results tables.

### Gloss—60°, Contrast Ratio, and Yellowing

Color and gloss measurements were done on films applied with a 3-mil wet-film drawdown bar (gap=6 mil, or 150 μm) to Leneta Form 3-B opacity charts. Additional drawdowns were made from the 60° C. heat-aged stability samples at the times indicated in the respective results tables. Panels dried at least 24 hours at room temperature before measurement.

Color measurements were done with a BYK-Gardner Color Guide Sphere color meter (D65 source/10° observer), which measures reflectance spectra in conformity to A.S.T.M. E 1164. The meter calculates color parameters according to the CIE L*a*b* color system. Yellowness is reported here in terms of the b* (yellow-blue scale) parameter; increasing yellowness is indicated by a greater positive value of b*. For each panel, results are reported as the average of measurements on four locations over the white background.

Contrast ratio (also known as opacity, a measure of hiding power), defined in A.S.T.M. D 2805, is the ratio of diffuse reflectance of a coating over a black substrate to that over a white substrate. The color meter determines percent opacity from successive measurements on coating film over the black and the white sections of the opacity charts. Measurements over four pairs of locations on each panel were averaged for each panel.

Gloss at 60° was measured with a BYK-Gardner micro-TRI-gloss meter, in accordance with A.S.T.M. D 523. Measurements over three locations over the white background of each panel were averaged.

### Freeze Thaw Resistance

The standard method A.S.T.M. D 2243 specifies a temperature of −18° C. (0° F.) for freeze-thaw resistance. However, due to the poor resistance of this low-solvent formula, freeze-thaw resistance was evaluated at −6° C. overnight. For accurate and stable temperature control, test paints in 50-mL centrifuge tubes samples, with paint sample submerged, were placed in the cooling fluid of a circulator bath. After thawing, samples were probed with a spatula and visually examined for gellation, flocculation, and large viscosity build, all of which indicate failure.

### Blocking Resistance

The blocking resistance was similar to A.S.T.M. D 4946, except that a test temperature of 25° C. was used instead of the specified temperature of 50° C. These conditions are commonly used for low VOC systems with less blocking resistance than conventional paints. Films of 3-mil wet-film thickness applied to opacity charts were dried at 50% relative humidity, 25° C., until testing at one, three, or seven days. For each test, coated panels for each paint were cut into triplicate pairs of 1½-inch squares. On top of each pair of squares, with coated surfaces in contact, was placed a No. 8 rubber stopper (smaller, 1.25-inch face on the squares), then a 1 kg weight was placed on the stoppers for one hour. After removal of the weights, pairs of squares were peeled apart with slow and steady force, observing the amount of adhesion. Adhesion resistance was rated according to A.S.T.M. D 4946 on a scale from 0 (lowest resistance, i.e., nearly complete coating failure) to 10 (best resistance, i.e., no tack).

### Scrub Resistance

Wet-scrub resistance was measured with a Gardco Model D10 washability tester, (Paul N. Gardner Company Inc.), with a fixed speed of 37 cycles per minute, according to A.S.T.M. D 2486. The paints were drawn on Leneta P-121-10N black plastic panels with the 7-mil (175-μm) gap side of a Dow Latex bar. The panels dried 7 days at 50% relative humidity at 25° C. The panels were secured to the stage of the scrub tester with shims under each of the side-by-side films, to give a raised test area. Before each 400 cycles of the test, 10 g of the specified abrasive medium and 5 mL water were placed in the path of the scrub brush. The endpoint for each paint was recorded when the brush wore a continuous line of complete paint removal across the width of the raised test surface. For the replicate test, left-right orientation of the side-by-side paints was reversed to correct for asymmetry in the tester.

### Example 1

### Comparative Neutralization

Very low VOC or no VOC additives such as DMTA (N,N-dimethyl-tris-hydroxymethylaminomethane), AMP-dimer 2,2′-((2-hydroxytrimethylene)diimino)bis(2-methyl-1-propanol) and TA-ACyHM 2-((1-aminocyclohexyl)methylamino)-2-(hydroxymethyl)propane-1,3-diol are effective at the dispersal of pigments but have lower neutralizing efficiency than AMP, the established amine neutralizer. Table 1, below shows the amounts of the low VOC amines needed (75-80% more by weight) vs. AMP to achieve the desired pH in an acrylic binder system.

TABLE 1

| | | | AMP- |
|---|---|---|---|
| Formula | AMP-95 | DMTA | dimer |
| water | 100.00 | 100.00 | 100.00 |
| Cellosize QP-300 thickener | 1.50 | 1.50 | 1.50 |
| Canguard BIT 20-AS biocide | 0.50 | 0.50 | 0.50 |
| propylene glycol | 10.00 | 10.00 | 10.00 |
| Tamol 731A dispersant, 25% active | 7.00 | 7.00 | 7.00 |
| potassium tripolyphosphate (KTPP) | 1.50 | 1.50 | 1.50 |
| Ecosurf SA-9 surfactant | 2.00 | 2.00 | 2.00 |
| Drewplus Y-381 defoamer | 1.00 | 1.00 | 1.00 |
| TiPure R-902+ titanium dioxide | 225.00 | 225.00 | 225.00 |
| Polygloss 90 kaolin clay | 25.00 | 25.00 | 25.00 |
| water | 30.00 | 30.00 | 30.00 |
| UCAR Latex DA 633 (acrylic) | 425.00 | 425.00 | 425.00 |
| water | 174.40 | 174.40 | 174.40 |
| Acrysol RM 5000, HEUR thickener, | 32.00 | 32.00 | 32.00 |
| 18.5% | | | |
| amine active | 1.48 | 2.60 | 2.71 |
| Drewplus Y-381 defoamer | 1.50 | 1.50 | 1.50 |
| water | 10.00 | 8.87 | 8.77 |
| Total | 1047.88 | 1047.87 | 1047.88 |
| pH | 9.54 | 9.29 | 9.22 |

### Example 2

### Reduced Amounts of Diamine Alcohol Required Compared to AMP or mono-amine DMTA

The diamino alcohol compounds of Formulas I or II are lower efficiency, higher cost neutralizers, but when used in combination with a strong base, such as sodium hydroxide to provide alkali metal cations, in accordance with the present invention, no-VOC paint formulations are produced having excellent film properties comparable to the paints obtained with AMP. Table 2, below highlights the reduction in the amount of amines in a vinyl acrylic binder formulation.

TABLE 2

| | | | AMP- |
|---|---|---|---|
| | AMP-95 | DMTA | dimer |
| | lb/100 | lb/100 | lb/100 |
| Formula | gallon | gallon | gallon |
| Water | 80.00 | 80.00 | 80.00 |
| Attagel 50 clay thickener | 3.00 | 3.00 | 3.00 |
| Canguard BIT 20-AS - Biocide | 0.50 | 0.50 | 0.50 |
| Propylene glycol | 7.00 | 7.00 | 7.00 |
| Tamol 1124 dispersant, 50% active | 5.00 | 3.75 | 3.75 |
| Potassium tripolyphosphate (KTPP) | 0.50 | 0.50 | 0.50 |
| Ecosurf SA-9 - Surfactant | 2.00 | 2.00 | 2.00 |
| Drewplus Y-381 - Defoamer | 1.00 | 1.00 | 1.00 |
| Amine active (added as 20% solution) | 4.00 | 4.00 | 2.40 |
| NaOH, solid (added as 20% solution) | 0.00 | 0.80 | 1.12 |
| Water, in amine & OH sol'ns | 0.21 | 23.20 | 19.68 |
| Water | 30.00 | 8.00 | 13.00 |
| TiPure R-902+ Titanium Dioxide | 225.00 | 225.00 | 225.00 |
| Polygloss 90 Kaolin Clay | 30.00 | 30.00 | 30.00 |
| Water | 40.00 | 40.00 | 40.00 |
| UCAR Latex 300 - Vinyl Acrylic | 400.00 | 400.00 | 400.00 |
| UCAR Latex 6030 - Acrylic | 60.00 | 60.00 | 60.00 |
| Water | 110.00 | 110.00 | 110.00 |
| Optifilm Enhancer 400 - Coalescent | 4.00 | 4.00 | 4.00 |
| Drewplus Y-381 - Defoamer | 1.50 | 1.50 | 1.50 |
| Acrysol TT-935 - Rheology Modifier | 10.00 | 10.00 | 10.00 |
| Acrysol 5000 - Rheology Modifier | 20.00 | 20.00 | 20.00 |
| Water | 17.72 | 19.99 | 20.09 |
| Drewplus Y-381 - Defoamer | 1.00 | 1.00 | 1.00 |
| Total | 1052.43 | 1055.24 | 1055.54 |

TABLE 3
Summary of Paint Composition Properties

| | | | AMP- |
|---|---|---|---|
| Properties | AMP-95 | DMTA | Dimer |
| Amine level | 4 | 4 | 2.4 |
| Hydroxide | none | NaOH | NaOH |
| pH | 8.49 | 8.52 | 8.47 |
| Viscosity (KU) | 88 | 85 | 86 |
| ICI viscosity (P) | 1.36 | 1.27 | 1.26 |
| Gloss, 60° | 51.8 | 51.0 | 51.3 |
| Opacity, % | 96.45 | 96.36 | 96.65 |
| Yellowness (b*) | 2.16 | 2.16 | 2.16 |
| Freeze/Thaw Resistance @ −6° C., | 1 | 0 | 5 |
| cycles passed | | | |
| Scrub resistance (% relative to AMP | Reference, | −3.4 | −9.4 |
| reference) | 2996 | | |
| | cycles | | |
| | average | | |
| Wet Adhesion, 3 day, % removed @ | 0-1 | 0 | 2 |
| 500 cycles | | | |
| Δ % removed vs. AMP reference | Ref | 0 | 1 |
| Blocking resistance @ 25° C.: 1 day | 4 | 4 | 4 |
| Blocking resistance @ 25° C., 3 days | 3 | 3 | 5 |
| Blocking resistance @ 25° C., 7 days | 3 | 3 | 5 |
| Tinted with phthalocyanine blue: L* | 79.51 | 79.52 | 79.33 |
| initial | | | |
| a* initial | −11.94 | −11.90 | −11.91 |
| b* initial | −21.05 | −21.02 | −21.14 |
| ΔE*, rolled 7 days | 0.20 | 0.11 | 0.36 |

As can be seen from the data presented in Table 2 above, while the pH of the paint formula in Table 2 was brought to that of the AMP benchmark using an equal weight amount of DMTA (equal to amount AMP required), along with addition of NaOH, 40% less AMP-dimer, along with NaOH addition, brought the pH of the paint formula to that of the AMP benchmark.

The blocking resistance of the DMTA/NaOH-containing paint formula matches that of the AMP benchmark, the AMP-dimer/NaOH-containing paint formula shows improved blocking resistance over the AMP benchmark. The AMP-dimer/NaOH-containing formula also shows strong improvement in the freeze-thaw stability over the AMP benchmark.

Scrub resistance for both DMTA and AMP-dimer/NaOH-containing paint formulations was slightly less than for the AMP benchmark

Various other properties of the DMTA and AMP-dimer/NaOH-containing paint formulations remained comparable or equivalent to the AMP benchmark, including wet adhesion, KU viscosity, ICI viscosity, opacity, gloss, yellowness and color acceptance.

### Example 3

### High Throughput Testing

Table 4 below lists 11 sample paint recipes containing low VOC amino alcohols, and shows that when combined with inorganic base, the low VOC amino alcohols can effectively neutralize paint formulation (at amine active levels equal or less than AMP-95 formulation) without detrimental affects to formulation and/or coating properties.

Formulations 1-3 include TA-ACyHM with NaOH or KOH; Formulations 4-6 include DMTA with NaOH or KOH; and Formulations 7-11 include AMP-Dimer with NaOH or KOH. Amine active level for these formulations (1-11) range from 2.63 lbs/100 gal to 4.09 lbs/100 gal. Standard formulation with AMP-95 has amine active level at 4 lbs/100 gal. The reported measurements are in comparison to the standard formulation (with AMP-95) and correlation was performed by scaling up to a laboratory scale formulation and performing the appropriate ASTM tests. Formulation properties (pH and viscosity) and coating properties (opacity, gloss) are comparable between all low VOC formulations (1-11) and the standard formulation containing AMP-95. In addition, the reported water resistance properties (scrub resistance and wet adhesion) for formulations 1-11 are comparable or improved over the standard formulation having AMP-95. Scrub resistance of a coating is reported as delta thickness in mils, with improved scrub resistant coatings showing lower delta thickness. Wet adhesion is reported as a % white number, which is an indication of amount of coating left on a substrate after the test. A higher % white number indicates better wet adhesion properties. Both scrub resistance and wet adhesion test methods are explained in the experimental section. In addition, properties of formulations 1-11 are generally comparable (including scrub and wet adhesion) to formulation 12 which contains Vantex-T (commercial product), at 9 lbs/100 gal amine active loading.

TABLE 4
Recipe examples with Formulation and Coating properties

| | | | | | Inor- | | | | Mid | | | | | | wet |
|---|---|---|---|---|---|---|---|---|---|---|---|---|---|---|---|
| | | | | | ganic | Pro- | | | shear | High | | | | Scrub- | adhe- |
| | | Amino | | Amine | Level | pylene | Tamol | | Corre- | shear | | | | Delta | sion |
| | | Alcohol | | Active | (dry) | Glycol | 1124 | | lated | vis- | | | | Thick- | (1 day) |
| Formu- | | lbs/ | Inor- | lbs/ | lbs/ | lbs/ | lbs/ | pH_1 | Vis- | cosity | | Gloss | Gloss | ness | % |
| lation# | N | 100 gal | ganic | 100 gal | 100 gal | 100 gal | 100 gal | Day | cosity | p | Opacity | (20) | (60) | mils | White |
| Std | 12 | AMP-95 | | 4.00 | | 7.00 | 5.00 | 8.37 ± | 90.94 ± | 1.30 ± | 95.66 ± | 9.71 ± | 46.64 ± | 0.38 ± | 35.46 ± |
| | | | | | | | | 0.2 | 7.5 | 0.11 | 1.5 | 1.3 | 3.2 | 0.1 | 15.2 |
| 1 | 1 | TA- | NaOH | 2.63 | 0.98 | 3.50 | 2.50 | 8.19 | 96.00 | 2.00 | 96.98 | 5.62 | 35.61 | 0.21 | 72.49 |
| | | ACyHM | | | | | | | | | | | | | |
| 2 | 1 | TA- | NaOH | 3.76 | 0.79 | 5.25 | 2.50 | 8.70 | 92.53 | 1.25 | 95.14 | 8.46 | 43.08 | 0.83 | 61.19 |
| | | ACyHM | | | | | | | | | | | | | |
| 3 | 1 | TA- | KOH | 3.53 | 1.09 | 7.00 | 5.00 | 8.27 | 86.35 | 1.26 | 97.12 | 10.58 | 47.05 | 0.30 | 99.03 |
| | | ACyHM | | | | | | | | | | | | | |
| 4 | 1 | DMTA | NaOH | 3.96 | 0.78 | 7.00 | 5.00 | 8.90 | 88.07 | 1.47 | 97.22 | 12.28 | 51.75 | 0.52 | 38.56 |
| 5 | 1 | DMTA | KOH | 3.03 | 1.40 | 7.00 | 5.00 | 8.10 | 81.27 | 0.87 | 96.94 | 15.66 | 56.24 | 0.31 | 35.88 |
| 6 | 1 | DMTA | KOH | 3.66 | 1.10 | 7.00 | 2.50 | 9.00 | 89.87 | 1.45 | 97.56 | 5.81 | 43.33 | 0.37 | 47.40 |
| 7 | 1 | AMP- | NaOH | 4.09 | 0.80 | 7.00 | 2.50 | 8.23 | 87.40 | 1.20 | 96.06 | 10.02 | 47.58 | 0.00 | 84.05 |
| | | Dimer | | | | | | | | | | | | | |
| 8 | 1 | AMP- | NaOH | 2.81 | 0.99 | 7.00 | 5.00 | 8.50 | 88.66 | 1.30 | 96.84 | 11.98 | 51.65 | 0.41 | 32.75 |
| | | Dimer | | | | | | | | | | | | | |
| 9 | 1 | AMP- | NaOH | 3.97 | 0.78 | 3.50 | 5.00 | 8.80 | 86.06 | 1.29 | 94.60 | 9.02 | 45.63 | 0.68 | 98.30 |
| | | Dimer | | | | | | | | | | | | | |
| 10 | 1 | AMP- | KOH | 3.64 | 1.10 | 5.25 | 3.75 | 8.68 | 86.36 | 1.38 | 96.64 | 9.34 | 44.41 | 0.42 | 53.27 |
| | | Dimer | | | | | | | | | | | | | |
| 11 | 1 | AMP- | KOH | 3.01 | 1.41 | 7.00 | 2.50 | 8.48 | 89.84 | 1.42 | 96.77 | 12.27 | 52.97 | 0.35 | 68.12 |
| | | Dimer | | | | | | | | | | | | | |
| 12 | 1 | Vantex- | | 9.40 | 0.00 | 7.00 | 5.00 | 8.49 | 85.34 | 1.15 | 96.26 | 14.86 | 55.93 | 0.16 | 59.15 |
| | | T | | | | | | | | | | | | | |

### Formulation Recipes:

Table 5 below lists all ingredients of paint recipe used in the high throughput study of Example 3 study. Type and amount of amino alcohol and amount of Tamol 1124 and propylene glycol were varied between different formulations. Other ingredients were kept at same concentration. The formulations were made with a high throughput method involving preparing latex paint formulations from grind components. The order of addition for recipe components was kept similar to those used in Examples 1 and 2. However, some ingredients were combined together, into soluble streams, to reduce the number of additions, during the high throughput tests. Table 5 shows the color coded ingredients that were added together, with order of addition marked next to each set. Solids were dispensed into 10 ml vials with an auto dose MTM Powdernium solid handling robot (commercially available from Freeslate, located in Sunnyvale, Calif., U.S.A.). The liquid components of grind and let down were added using Hamilton Microlab Star liquid handling robot (commercially available from Hamilton Robotics, located in Reno, Nev., U.S.A.). A Lab Ram, Resodyn acoustic mixer was used to mix all ingredients together at 60% intensity for 3 mins. The formulations were further mixed in a Flack Tek DAC150 Speed Mixer at 1500 rpm for 2 mins, to remove air bubbles.

TABLE 5
ingredients and mixtures thereof used for paint
compositions studied in high throughput testing

| Feed Stream | Ingre- | | | |
|---|---|---|---|---|
| No. (in order | dient | | | milli- |
| of addition) | No. | Ingredient Name | grams | liters |
| 1 | 1 | Polygloss 90 kaolin clay | 0.200 | 0.077 |
| | | (formerly Huber, now KaMin | | |
| | 2 | TiPure R-902+ titanium | 1.497 | 0.377 |
| | | dioxide (DuPont) | | |
| | 3 | Attagel 50 clay thickener | 0.020 | 0.008 |
| | | (Engelhard) | | |
| 2 | 4 | water | 0.67 | 0.067 |
| | 5 | Tamol 1124 dispersant | 0.17 | 0.014 |
| | | (Rohm & Haas) | | |
| 3 | 6 | Water | 0.067 | 0.067 |
| | 7 | Potassium tripolyphosphare | 0.003 | 0.001 |
| | | (KTPP)(FMC Corp) | | |
| | 8 | Ecosurf SA-9 surfactant (Dow) | 0.013 | 0.014 |
| | | Amino alcohol solution (20% | | |
| | | solution) | | |
| 4 | 9 | AMP-95, diluted to 20% active | 0.299 | 0.304 |
| 5 | 10 | Propylene glycol, industrial | 0.020 | 0.019 |
| | | grade (Dow) | | |
| 6 | 11 | Drewplus Y-381 defoamer | 0.033 | 0.038 |
| | | (Ashland Water Technology) | | |
| 7 | 12 | water | 0.532 | |
| | 13 | UCAR Latex 300 (Dow) | 2.662 | |
| | 14 | UCAR Latex 6030 (Dow) | 0.399 | |
| | 15 | Optifilm Enhancer 400 reactiove | 0.027 | |
| | | coalescent (Eastman) | | |
| | 16 | Acrysol TT-935 HASE | 0.067 | |
| | | thickener (Rohm & Haas) | | |
| | 17 | Acrysol RM 5000, HEUR | 0.133 | |
| | | thickener, 18.5% (Rohm&Haas) | | |
| 8 | 18 | NaOH | 0.48 | 0.48 |
| | | Inorganic solution (0.75% | | |
| | | solution) | | |
| 9 | 19 | water (after calculating | 0.892 | 0.892 |
| | | volumes for amine, OH Tamol | | |
| | | Formula Total | 6.995 | 5.551 |

We claim:

1. A coating composition comprising a binder, a carrier, a pigment, cations selected from the group consisting of alkali metal cations, ammonium cations, and mixtures thereof, and at least one diamino alcohol selected from the group consisting of:
A) a compound of Formula I as follows: 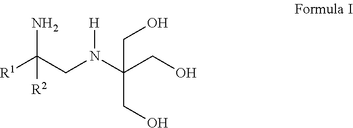
wherein, wherein R¹ and R² are independently C₁-C₁₀ alkyl, or R¹ and R², together with the carbon to which they are attached, form a C₃-C₁₂ cycloalkyl ring optionally substituted with C₁-C₆ alkyl; and
B) a compound of Formula II as follows: 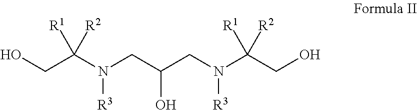
or salt thereof, wherein R¹ and R² are independently at each occurrence C₁-C₆ alkyl; and R³ is independently at each occurrence H or C₁-C₆ alkyl.

2. The coating composition according to claim 1, wherein said at least one diamino alcohol is a compound of Formula I which comprises 2-((1-aminocyclohexyl)methylamino)-2-(hydroxymethyl)propane-1,3-diol.

3. The coating composition according to claim 1, wherein said at least one diamino alcohol is a compound of Formula II which comprises 2,2′-((2-hydroxytrimethylene)diimino)bis(2-methyl-1-propanol).

4. The coating composition according to claim 1, wherein said carrier comprises water and said coating composition is an aqueous paint composition.

5. The coating composition according to claim 1, having a volatile organic compound (VOC) content of less than 50 grams per liter of VOC, based on the total volume of said coating composition.

6. A method for reducing the volatile organic compound (VOC) content of a coating composition having a binder, a carrier, and a pigment, said method comprising including in the coating composition:
A) cations selected from the group consisting of alkali metal cations, ammonium cations, and mixtures thereof; and
B) an effective amount of at least one diamino alcohol selected from the group consisting of:
1) a compound of Formula I as follows: 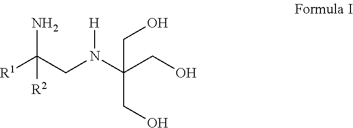
wherein, wherein R¹ and R² are independently C₁-C₁₀ alkyl, or R¹ and R², together with the carbon to which they are attached, form a C₃-C₁₂ cycloalkyl ring optionally substituted with C₁-C₆ alkyl; and
2) a compound of Formula II as follows: 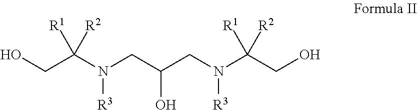
or salt thereof, wherein R¹ and R² are independently at each occurrence C₁-C₆ alkyl; and R³ is independently at each occurrence H or C₁-C₆ alkyl.

7. The method according to claim 6, wherein said at least one diamino alcohol is a compound of Formula I which comprises 2-((1-aminocyclohexyl)methylamino)-2-(hydroxymethyl)propane-1,3-diol.

8. The method according to claim 6, wherein said at least one diamino alcohol is a compound of Formula II which comprises 2,2′-((2-hydroxytrimethylene)diimino)bis(2-methyl-1-propanol).

9. The method according to claim 6, wherein said carrier comprises water and said coating composition is an aqueous paint composition.

10. The method according to claim 6, wherein the volatile organic compound (VOC) content of said coating composition is less than 50 grams per liter of VOC, based on the total volume of said coating composition.
